(19) United States
(12) Patent Application Publication
(10) Pub. No.: US 2011/0149340 A1
(43) Pub. Date: Jun. 23, 2011

(54) METHOD, SYSTEM AND COMPUTER PROGRAM PRODUCT FOR MANIPULATING A GRAPHIC ENTITY

(75) Inventors: Yaron Lipman, Netser-Sereni (IL); David Levin, Tel Aviv (IL); Daniel Cohen-Or, Hod Hasharon (IL)

(73) Assignee: Ramot at Tel-Aviv University Ltd., Tel Aviv (IL)

(21) Appl. No.: 12/864,879

(22) PCT Filed: Jan. 27, 2009
(86) PCT No.: PCT/IL09/00102

§ 371 Date: Mar. 14, 2011

Related U.S. Application Data
(60) Provisional application No. 61/024,575, filed on Jan. 30, 2008.

(51) Int. Cl. G06T 17/00; G06F 15/00

(52) U.S. Cl. 358/1.15; 345/420

(57) ABSTRACT

A system, a method and a computer program product for manipulating a graphic entity. The method includes: receiving first cage vertices information, second cage vertices information and second cage face orientation information; wherein the graphic entity is at least partially surrounded by the first cage and wherein a transformed graphic entity is expected to be is at least partially surrounded by the second cage; transforming the graphic entity to provide a transformed graphic entity in response to information representative of the graphic entity, second cage vertices information and second cage face orientation information.

### RELATED APPLICATIONS

This application claims the priority of U.S. provisional patent 61/024,575 filing date 30 Jan. 2008.

### FIELD OF THE INVENTION

The present invention relates to a system, method and a computer program product for manipulating a graphic entity.

### BACKGROUND OF THE INVENTION

Space deformation techniques were introduced by Sederberg and Parry [1986] and further extended by others [Coquillart 1990; Mac-Cracken and Joy 1996; Kobayashi and Ootsubo 2003]. The basic space deformation technique defines a lattice with a rather small number of control points that encloses the subject model. Manipulating the control points smoothly deforms the space enclosed in the lattice, and the embedded geometry deforms accordingly. As indicated in [Joshi et al. 2007], the rigid spatial topological structure of the FFD lattices makes the deformation less flexible. This motivated a search for a more general control polyhedron to enclose the model in a tighter fashion and have a better match of degrees of freedom to the subject model.

Floater [2003] has introduced the Mean Value Coordinates (MVC) for 2D polygons as a closed-form scheme for smoothly interpolating data on general polygons. Later [Ju et al. 2005b; Floater et al. 2005; Langer et al. 2006] have further generalized the Mean Value Coordinates to 3D. Ju et al. [2005b] presented a surface deformation technique based on these coordinates. The MVC have been subject to investigations that are more theoretical and have proved to be well defined in the whole plane and infinitely smooth except at the vertices [Hormann and Floater 2006]. Joshi et al. [2007] introduced different cage-based coordinates called Harmonic Coordinates. These coordinates are non-negative and do not possess a local extreme. These properties lead to more intuitive control in the deformation process, mainly of highly concave cages, compared to the original MVC. However, Harmonic Coordinates do not possess closed-form formulas as MVC. Later, Lipman et al. [2007] presented alternative coordinates which are also non-negative. As we discussed in the introduction, all these methods are affine-invariant and not shape preserving. Another alternative to compute space deformations is employing scattered-data interpolation methods like RBF [Kojekine et al. 2002; Botsch and Kobbelt 2005]. However, in these methods also each axis is treated independently and hence shape preservation is generally not possible. For a more complete discussion of previous work we note that previously to Floater's 2D Mean Value Coordinates there was a considerable amount of work done generalizing the barycentric coordinates to general polygons and polyhedra [Wachpress 1975; Pinkall and Polthier 1993; Warren 1996; Meyer et al. 2002; Ju et al. 2005a].

A different family of deformation techniques applies the deformation directly to the surface [Sorkine et al. 2004; Yu et al. 2004; Lipman et al. 2005; Zhou et al. 2005; Botsch et al. 2006; Huang et al. 2006; Sorkine and Alexa 2007; Au et al. 2007; Shi et al. 2007].

These methods are based on measuring some deformation energy directly over the surface, or representing the surface with some tailored structures, and then optimizing them under some user constraints to yield the desired deformation. These “direct” approaches achieve high quality shape-preserving deformation. However, these methods require solving large, often non-linear, systems of equations. Another significant downside is that such methods require discretization of high-order derivative quantities (usually curvatures or Laplacian operator) on the surface, which often introduces errors, and typically requires a well-behaved representation of the surface, such as mesh with well-shaped triangles. The technique that we present achieves similar shape-preservation quality as these direct methods. It consists of closed-form formulas and does not require the solution of linear or non-linear systems, and it is not prone to discretization errors.

In recent years there is an increased interest in cages as practical means to manipulate 3D models [Floater 2003; Ju et al. 2005b; Joshi et al. 2007]. A cage is a low polygon-count polyhedron, which typically has a similar shape to the enclosed object. The points inside the cage are represented by affine sums of the cage's vertices multiplied by special weight functions called coordinates. Manipulating the cage induces a smooth space deformation of its interior. The main advantage of these cage-based space deformation techniques is their simplicity, flexibility and speed. Manipulating an enclosed object, for example a mesh surface, requires a rather small computational cost, since transforming a point requires merely a linear combination of the cage geometry using pre-calculated coordinates. Moreover, since each point is deformed independently, these techniques are indifferent to the surface representation and free of discretization errors.

However, current space-deformation techniques do not have good control over the preservation of shape and details, such as advanced surface-based deformation techniques. Throughout the paper we use the phrase Shape-preserving deformations as our main target. Shape-preserving deformations are smooth mappings such that their Jacobian matrices are close to rotations with isotropic scale. Notice that shape-preservation is reflecting local behavior of the transformation. That is, the shear component of the local transformation is small. Shape-preserving transformations are also referred to as Quasi-conformal mappings.

While conformal mappings map infinitesimal balls into infinitesimal balls, with no shear at all, quasi-conformal mappings map infinitesimal balls into infinitesimal ellipsoids with bounded axis ratio.

Achieving shape-preserving space deformations defined by cage-based techniques seems unfeasible. The reason is that current cage methods express a point η, inside a cage P as an affine sum of the cage vertices. The exact equations are referred to as equations (1) and (2).

Equation (1) defines a point η, inside cage P as an affine sum of the cage vertices {Vᵢ} and equation (2) described the transformation:

The coordinates are defined as representing each interior point η as a linear combination:

η=F(η;P)=Σ_{iεIv}φᵢ(η)vᵢ (1)

Thus, the deformation induced by a deformed cage P′ is defined by:

η=F(η;P′)=Σ_{iεIv}φᵢ(η)v_{i,} (2)

These operators are affine-invariant. Consequently, when the cage undergoes an affine transformation, the operator reconstructs this affine transformation. Such affine transformations may include a shear and anisotropic scale that violates the shape-preserving property. Moreover, the general form of the current cage-based operators (Equation (1) and (2)) cannot produce shape-preserving mappings. This stems from the fact that respecting the requirement that the Jacobian consists of rotations and isotropic scaling, necessarily requires that the operator reflects a dependency between the different axes. However, in Equation (2) each axis is treated independently of the others. For example, translating the x-axis coordinate of one cage's vertex has no affect on the y and z-axis coordinates whatsoever. The effect of the affine invariance property can be seen for example in FIG. 3 where the details (bumps) maintain their original orientation under the translation of part of the cage.

There is a growing need to provide effective shape preserving transforms.

### SUMMARY OF THE INVENTION

A method for manipulating a graphic entity, the method includes: building a first cage with simplicial faces) surrounding the part of the entity which the user would like to deform, and a second cage, which is a deformation of the first cage. The deformation of the entity is then guided by the deformation of the first cage.

receiving first cage vertices information, second cage vertices information and second cage face orientation information; wherein the graphic entity at least partially surrounded by the first cage and wherein a transformed graphic entity is expected to be at least partially surrounded by the second cage; and transforming the graphic entity to provide a transformed graphic entity in response to information representative of the graphic entity, second cage vertices information and second cage face orientation information.

The second cage face orientation information can represent vectors that are oriented in relation to faces of the second cage.

The face orientation information can represent vectors that are the outward normal to faces of the second cage.

The method can include adding a first weighted sum of second cage vertices values to a second weighted sum of second cage face orientation values.

The method can include calculating or receiving first sum weights and second sum weights; wherein the first sum weights and the second sum weights are selected so that the transformation is characterized by linear reproduction translation invariance, rotation and scale invariance, shape preservation and smoothness.

The method can include representing the graphical entity as a sum of a third weighted sum of first cage vertices values and a fourth weighted sum of first cage face orientation values; wherein first sum weights equal third sum weights and second sum weights equal fourth sum weights.

The transforming can be conformal for a two dimensional graphical object and is quasi-conformal for a three dimensional graphical object.

The transforming can include extending the transformed graphic entity to an exterior of the second cage.

The first cage can be a partial cage that surrounds a graphic entity that is a part of a larger graphic entity; and the larger graphic entity can be not at least partially surrounded by the first cage.

The method can include displaying the transformed graphic entity.

The method can include printing the transformed graphic entity.

A computer readable medium that stores instructions for: receiving first cage vertices information, second cage vertices information and second cage face orientation information; wherein the graphic entity at least partially surrounded by the first cage and wherein a transformed graphic entity is expected to be at least partially surrounded by the second cage; and transforming the graphic entity to provide a transformed graphic entity in response to information representative of the graphic entity, second cage vertices information and second cage face orientation information.

The face orientation information can represent vectors that are oriented in relation to faces of the second cage.

The face orientation information can represent vectors that are the outward normal to faces of the second cage.

The computer readable medium can store instructions for adding a first weighted sum of second cage vertices values to a second weighted sum of second cage face orientation values.

The computer readable medium can store instructions for calculating or receiving first sum weights and second sum weights; wherein the first sum weights and second sum weights are selected so that the transformation is characterized by linear reproduction, translation invariance, rotation and scale invariance, shape preservation and smoothness.

The computer readable medium can store instructions for representing the graphical entity as a sum of a third weighted sum of first cage vertices values and a fourth weighted sum of first cage face orientation values; wherein first sum weights equal third sum weights and second sum weights equal fourth sum weights.

The transformation can be conformal for a two dimensional graphical object and can be quasi-conformal for a three dimensional graphical object.

The computer readable medium can store instructions for extending the transformed graphic entity to an exterior of the second cage.

The first cage can be a partial cage that surrounds a graphic entity that is a part of a larger graphic entity; wherein the larger graphic entity can be not at least partially surrounded by the first cage.

The computer readable medium can store instructions for displaying the transformed graphic entity.

The computer readable medium can store instructions for printing the transformed graphic entity.

A system for manipulating a graphic entity, the system includes: a memory unit for storing first cage vertices information, second cage vertices information and second cage face orientation information; wherein the graphic entity at least partially at least partially surrounded by the first cage and wherein a transformed graphic entity is expected to be at least partially surrounded by the second cage; and a processor adapted to transform the graphic entity to provide a transformed graphic entity in response to information representative of the graphic entity, second cage vertices information and second cage face orientation information.

The face orientation information can represent vectors that are oriented in relation to faces of the second cage.

The face orientation information can represent vectors that are the outward normal to faces of the second cage.

The processor can be adapted to add a first weighted sum of second cage vertices values to a second weighted sum of second cage face orientation values.

The processor can be adapted to calculate first sum weights and second sum weights; wherein the first sum weights and second sum weights are selected so that the transformation is characterized by linear reproduction, translation invariance, rotation and scale invariance, shape preservation and smoothness.

The memory unit can be configured to receive first sum weights and second sum weights; the first sum weights and the second sum weights are selected so that the transformation can be characterized by linear reproduction, translation invariance, rotation and scale invariance, shape preservation and smoothness.

The processor can be adapted to represent the graphical entity as a sum of a third weighted sum of first cage vertices values and a fourth weighted sum of first cage face orientation values; first sum weights equal third sum weights and second sum weights equal fourth sum weights.

The transformation can be conformal for a two dimensional graphical object and can be quasi-conformal for a three dimensional graphical object.

The processor can be adapted to extend the transformed graphic entity to an exterior of the second cage.

The first cage can be a partial cage that surrounds a graphic entity that can be a part of a larger graphic entity; the larger graphic entity can be not at least partially surrounded by the first cage.

The system can further include a display that can be configured to display the transformed graphic entity.

The system can further include a printer that can be configured to print the transformed graphic entity.

### SHORT DESCRIPTION OF THE DRAWINGS

The present invention will be understood and appreciated more fully from the following detailed description taken in conjunction with the drawings in which:

FIGS. 1a-1f, 2-10 and 12-14 of Appendix 0 illustrate various graphical entities, transformed graphical entities, according to an embodiment of the invention;

FIG. 11 of Appendix 0 illustrate various coordinate functions according to an embodiment of the invention;

FIG. 15 illustrate a method for manipulating a graphic entity according to an embodiment of the invention; and

FIG. 16 illustrates a system according to an embodiment of the invention.

### DETAILED DESCRIPTION OF THE DRAWINGS

So-called Green coordinates (weights) for closed polyhedral cages are provided. The coordinates can be motivated by Green's third integral identity and respect both the vertices position and face orientation of the cage. A transformation that uses these Green coordinates leads to space deformations with a shape-preserving property. In particular, in two-dimensional (2D) they induce conformal mappings, and extend naturally to quasi-conformal mappings in 3D. In both cases closed-form expressions are derived for the coordinates, yielding a simple and fast algorithm for cage-based space deformation. By comparing the performance of Green Coordinates with those of Mean Value Coordinates and Harmonic Coordinates it is shown that the advantage of the shape-preserving property is not achieved at the expense of speed or simplicity. According to an embodiment of the invention a transformed graphic element can extend the mapping in a natural analytic manner to the exterior of the cage, allowing the employment of partial cages.

Despite various limitations of prior art cage-based operators, it is still possible to define detail-preserving cage-based coordinates that retain all the advantages of the general cage-based operator. The coordinates that are present in appendix 0 introduce appropriate rotations into the space deformation to allow shape preservation. The mentioned below theory is applicable to piecewise-smooth cages in any dimension, and the resulting deformation operator does not require discretization. In 2D the operator is proved to induce a pure conformal mapping.

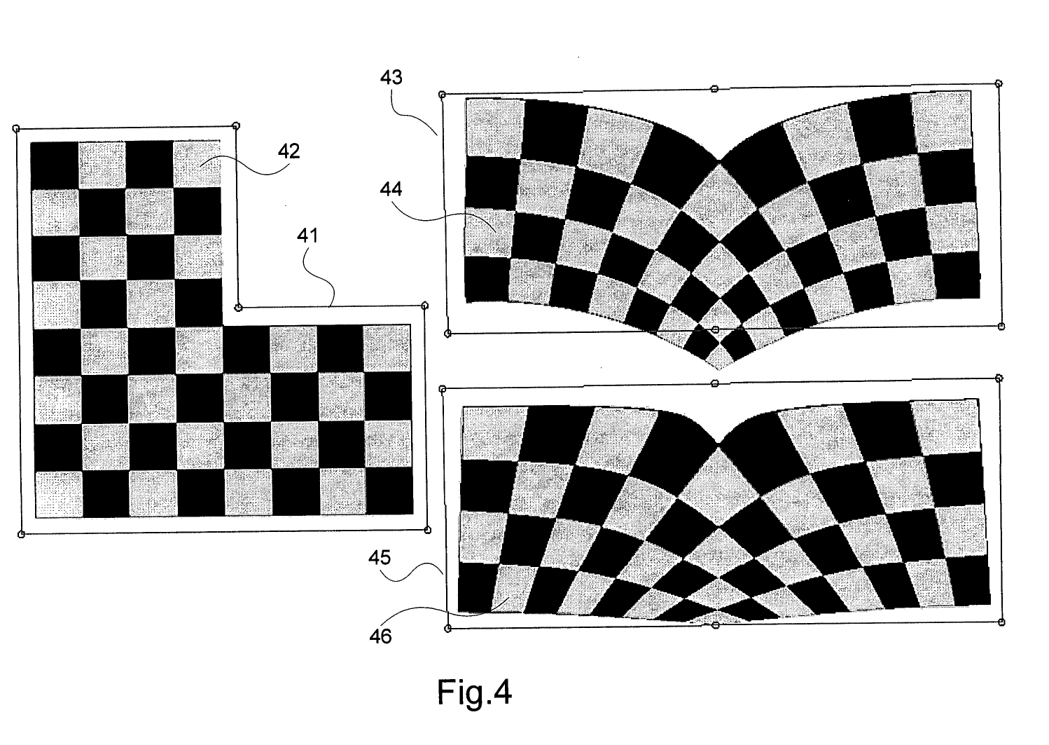

Conformal mappings are the ideal shape-preserving deformations since they locally consist of rotations and isotropic scaling only, that is angle preserving, see FIG. 4.

In 3D the operator provides a natural generalization of these conformal maps that is quasi-conformal maps. It should be noted that in 3D (and higher dimensions) no conformal mappings exist besides (composition of) similarity and inversion transformations [Blair 2000].

Quasi-conformal is a mapping that is dose to conformal in the sense that it allows a minimal amount of anisotropic scaling. We show the quasi-conformality empirically, that is, by checking that the distortion is bounded in 3D. Furthermore, in both cases the operator has a closed-form analytic formula. By the term closed-form we mean that the coordinates can be calculated analytically from the cage positions without approximation and discretization of any kind.

To achieve cage-based coordinates with shape-preserving property, there is a need in a slightly different operator than the one defined by equations (1) and (2).

The new coordinates respect the orientation of the cage's faces and not only the positions of the vertices. The transformation that is based upon these coordinates is illustrated by equations (3) and (4):

The coordinates are defined as representing each interior point η as a linear combination:

η=F(η;P)=Σ_{iεIv}φᵢ(η)vᵢ+Σ_{jεI}_{_{T}}ψⱼ(η)n(tⱼ) (3)

Thus, the deformation induced by a deformed cage P′ is defined by:

η=F(η;P′)=Σ_{iεIv}φᵢ(η)v′ᵢ+Σ_{jεI}_{_{T}}ψⱼ(η)rⱼn(t′ⱼ) (4)

Cage-based deformation methods employing Equation (1),(2) use generalized barycentric coordinates to construct a space deformation by an interpolation problem defined in each axis independently [Floater 2003; Ju et al. 2005b; Joshi et al. 2007].

Conveniently, different approach is taken in relation to deformations using coordinates: a mapping is defined F: R^{d}→R^{d} where the focus is the properties of the mapping itself rather than the properties of the coordinate functions only. The goal is to define a mapping that follows the deformation of the cage and is shape preserving.

To allow such deformations, the affine sum of Equation (1) is added to a term that employs the normals to the simplicial faces. This additional term augments the set of coordinates to include a coordinate per simplicial face. Thus, the Green Coordinates (GC) includes vertex coordinates, and face coordinates. A proper choice of these scalar coordinates leads to a mechanism that guarantees shape-preserving deformations under arbitrary cage manipulations.

The suggested method, similarly to previous cage-based methods, allows fast interactive deformation that only require to compute linear sums (see equation (4) of Appendix 0) with the pre-calculated coordinates. For the preprocess of calculating the coordinates closed-form formulas are derived.

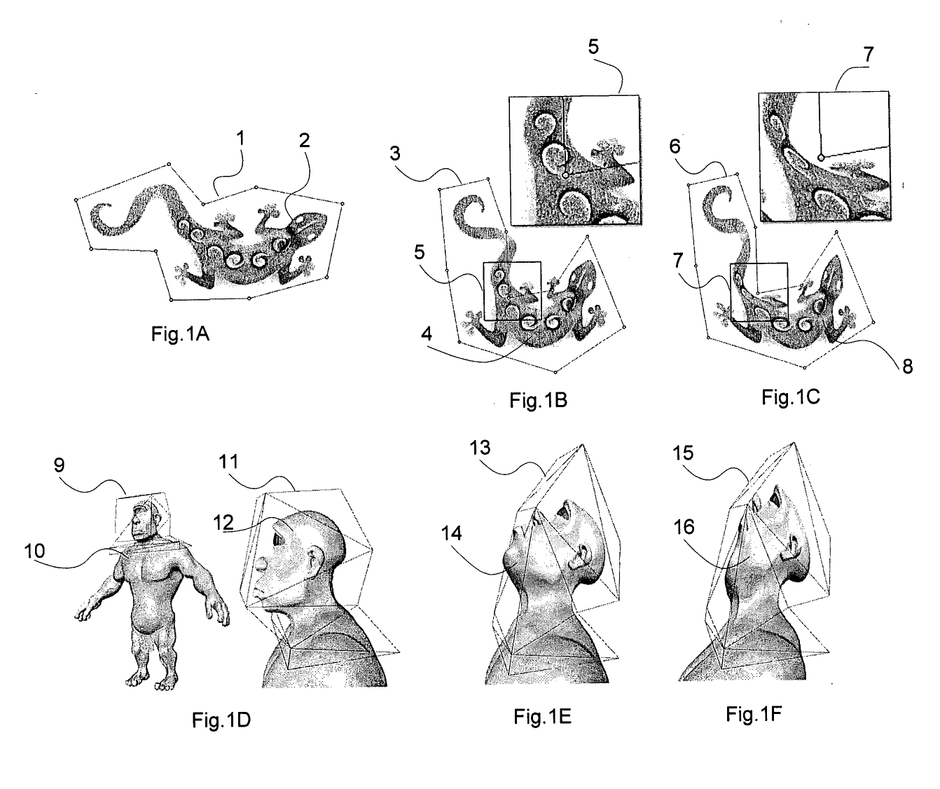

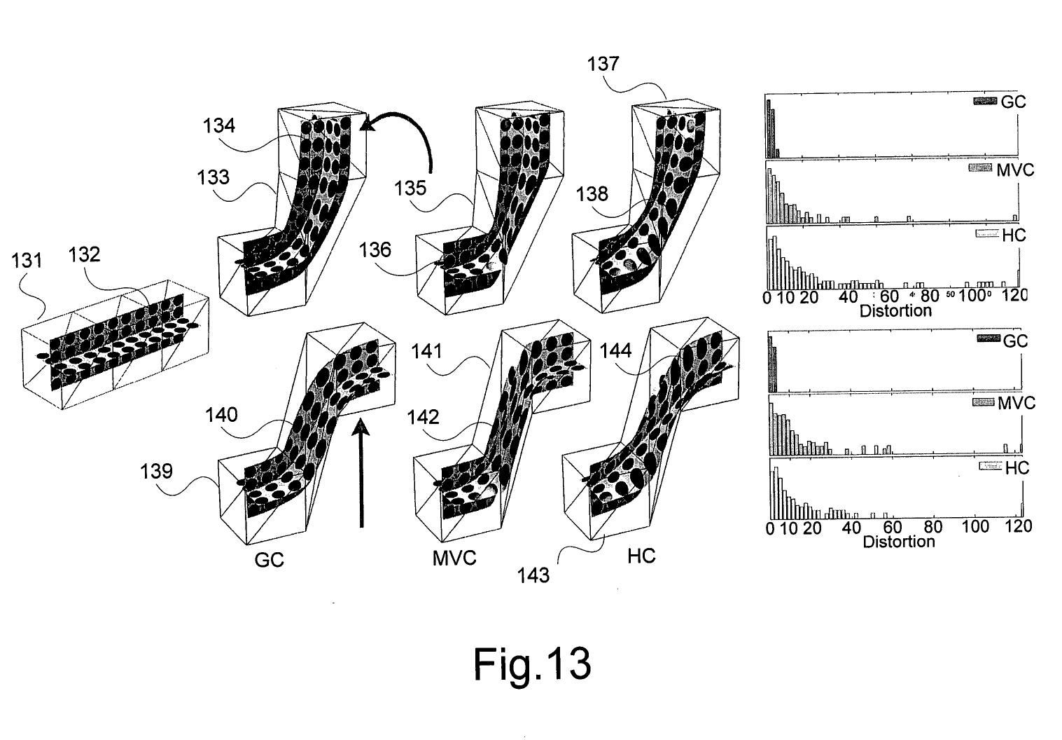

FIGS. 1a-1c illustrate 2D deformation, comparing Harmonic Coordinates (HC) [Joshi et al. 2007], and Green Coordinates (GC). In this example the inventors articulated the tail of the gecko by manipulating the cage. As can be observed, the conformality of the deformation produced by Green Coordinates better preserves the shape. The Harmonic coordinates, on the other hand, are affine-invariant and as such may contain shears and non-uniform scaling. However, the HC deformation better adheres the cage than the GC deformation, in a sense, the shape preservation property becomes possible due to relaxation of the interpolation requirement. As can be observed in this figure, not insisting on interpolating the cage's boundaries allows the deformation to preserve the shape. Moreover, the shape-preserving property also helps preventing local fold overs (see FIG. 13).

FIGS. 1d-1f illustrates a similar comparison, now with Mean Value Coordinates (MVC) [Ju et al. 2005b] in 3D where the Ogre model is articulated. Note the preservation of the shape of the ogre's head, in particular his chin, mouth and forehead.

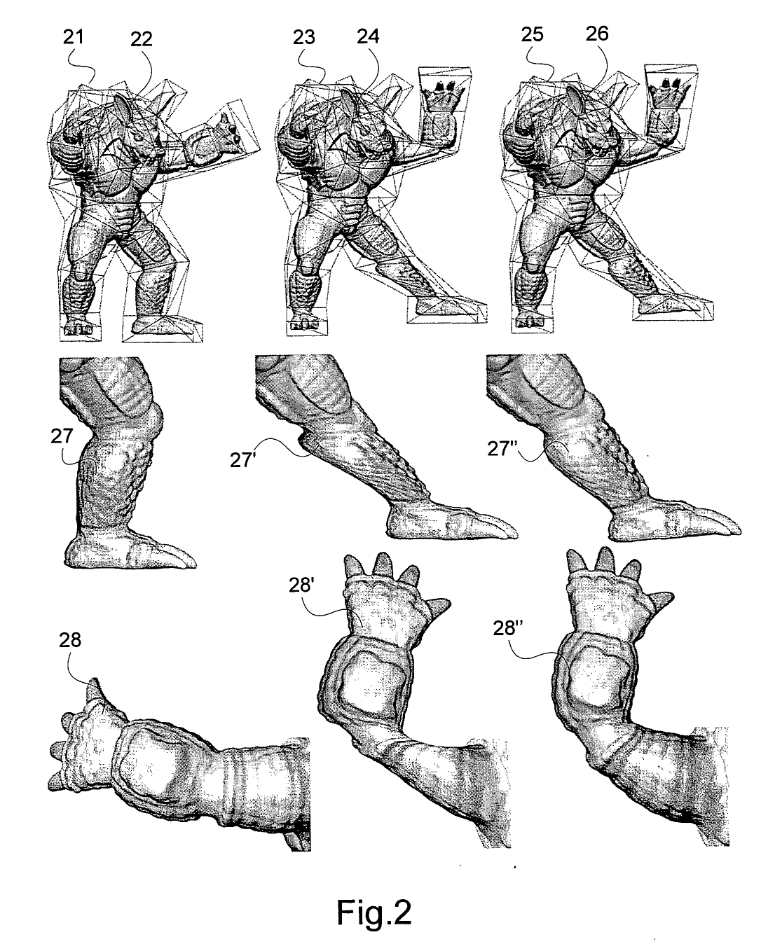

Another example is shown in FIG. 2, where the Armadillo's hand and leg are articulated. Note, that in these cases (not highly concave cages) employing the Harmonic Coordinates will yield similar results to the Mean Value Coordinates.

Section 3 titled “derivation of Green Coordinates” of Appendix 0 illustrated how the Green coordinates were derived and illustrates some of their properties. For example, the scaling factors of the weighted sums should be determined so that the mapping is linear, translation invariant, has rotation and scale invariance, shape preserves and is characterized by smoothness. Suggested values of the scaling factors are illustrated by equations (10) and (11) of Appendix 0.

In multi-dimensional spaces that have more than two dimensions the transformation is not a pure conformal mapping. Rather, the shear component of the transformation should be minimized. FIG. 13 illustrates that the maximal distortion of the green coordinate transformation is much lower than those of other transformations such as MVC and HC mappings.

FIG. 13 compares the deformation F induced by Green Coordinates, Mean Value Coordinates and Harmonic coordinates, using two orthogonal planes with a circles pattern. This figure also shows the histogram of the distortions of each of the maps, defined in the interior of the cage. Note that the maximal distortion of GC mapping in these examples does not exceed the value of 3.2, while the maximal distortion of MVC and HC mappings has exceeded the value of 100. Note that the Y-axis is shown in a logarithmic scale. Applying other transformations to the same cage, we noticed that, in exception of degenerate cases, the deformations induced by Green Coordinates have a maximal distortion bounded by a constant that is at least six. In contrast, the deformations induced by Mean Value Coordinates and Harmonic Coordinates present unbounded total distortion which is linearly proportional to the amount of distortion of the deformed cage.

It is noted that closed-form formulas can be derived for the dimensions of d=2, 3 which are the cases considered in this paper. The formulas' derivation is rather technical, so to keep the fluency of the reading we have attached only the final pseudo codes for calculating the 2D and 3D coordinates for ηεPⁱⁿ, as can be illustrated in algorithms 1 and 2 in Appendix A.

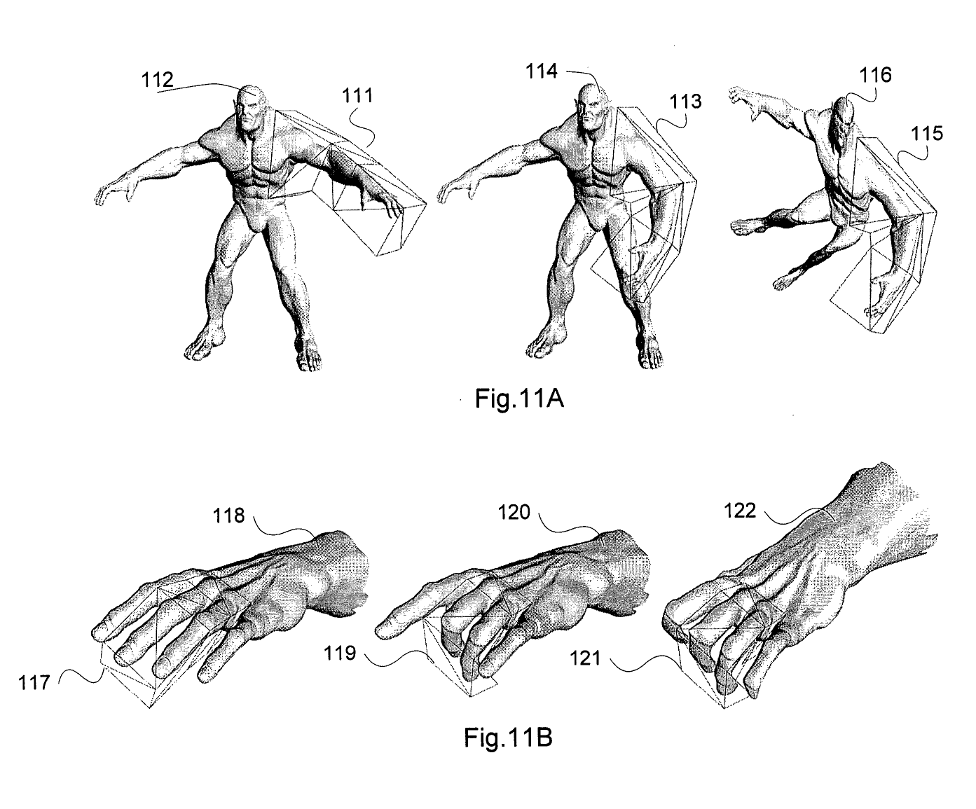

Extending to the cage's exterior. The Green Coordinates defined by Equations (4) and (9) are smooth in the interior of the cage P. However, each coordinate has jump discontinuities along the edges (simplicial faces) meeting at the cage vertices—as is illustrated in FIG. 11.

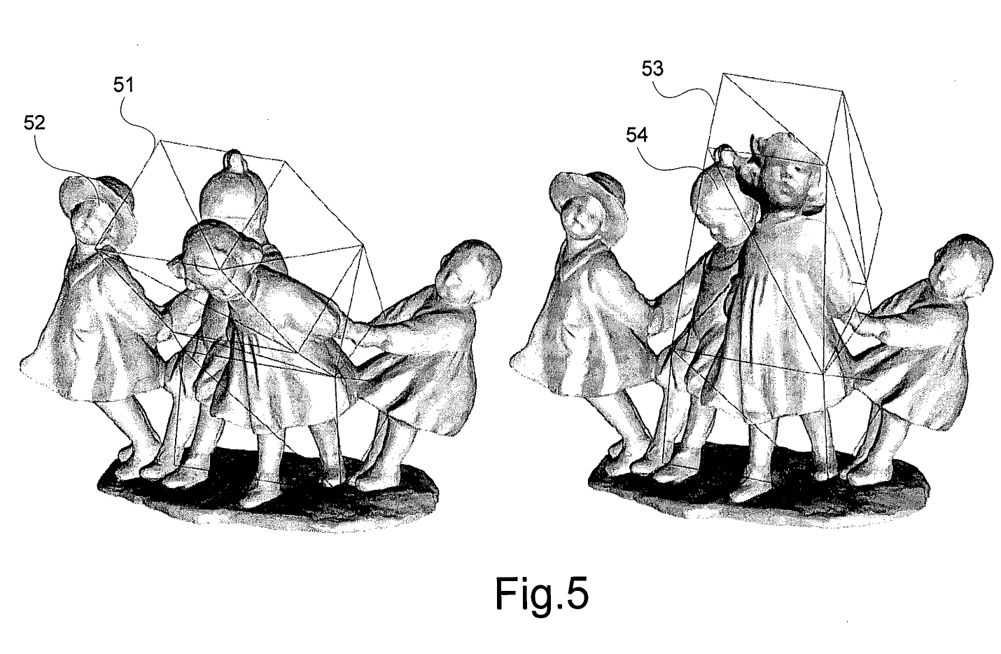

It has been shown that the green coordinates can be smoothly extended to the exterior of P. In 2D the Green Coordinates induce conformal transformations of the interior of P, and the above question is addressing the analytic continuation of these conformal transformations through the boundaries of P. An important application of such an extension is the deformation of a certain region of an object by a partial cage only, for example see FIG. 5. A proper extension to the exterior of the partial cage would have smooth transition to the rest of the object and a diminishing influence, leaving the rest of the object in place.

There is provided an analytic continuation of the coordinates outside the cage, and that requires only a rather slight modification to the closed-form formulas at hand. Equation (16) of provides the slightly amended transformation:

η=F(η;p′)=Σ_{iεIv}\tilde{φ}ᵢ(η)v′ᵢ+Σ_{jεI}_{_{T}}\tilde{ψ}ⱼ(η)rⱼn(t′ⱼ) (16)

A detailed description of the amended transformation is provided in Appendix 0.

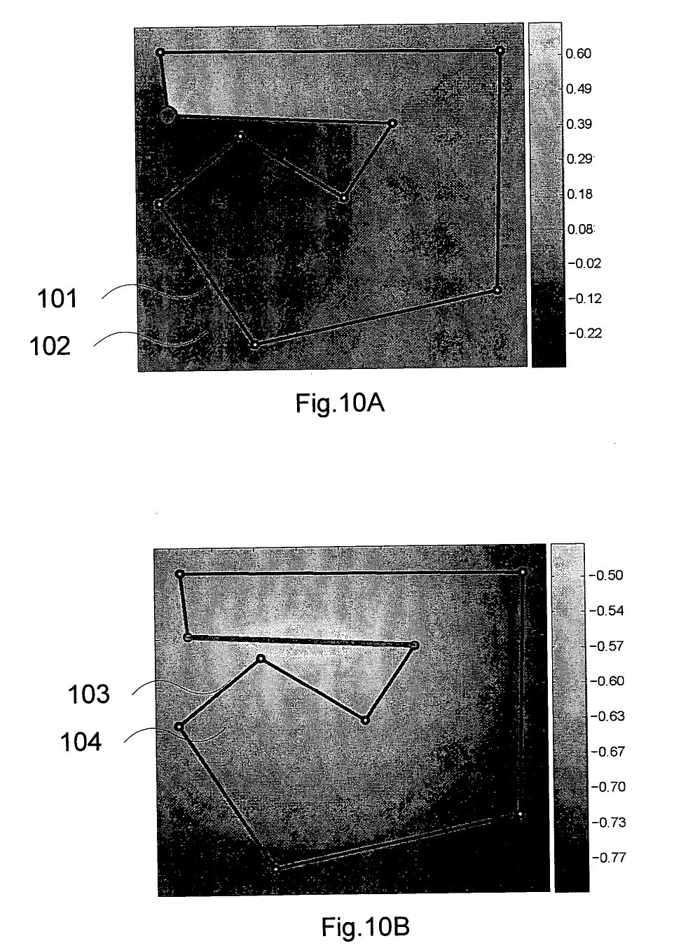

Deformation with partial cages. The above procedure of the coordinate extension allows the employment of partial cages. The construction of cages around the entire model may not always be simple, while fitting partial cages around the region of interest is rather simple. Canonical simple shaped cages can then be used as tools for local deformation. FIG. 10 shows an example of a simple cage fitted twice: once to the whole arm of the character and once to two fingers only.

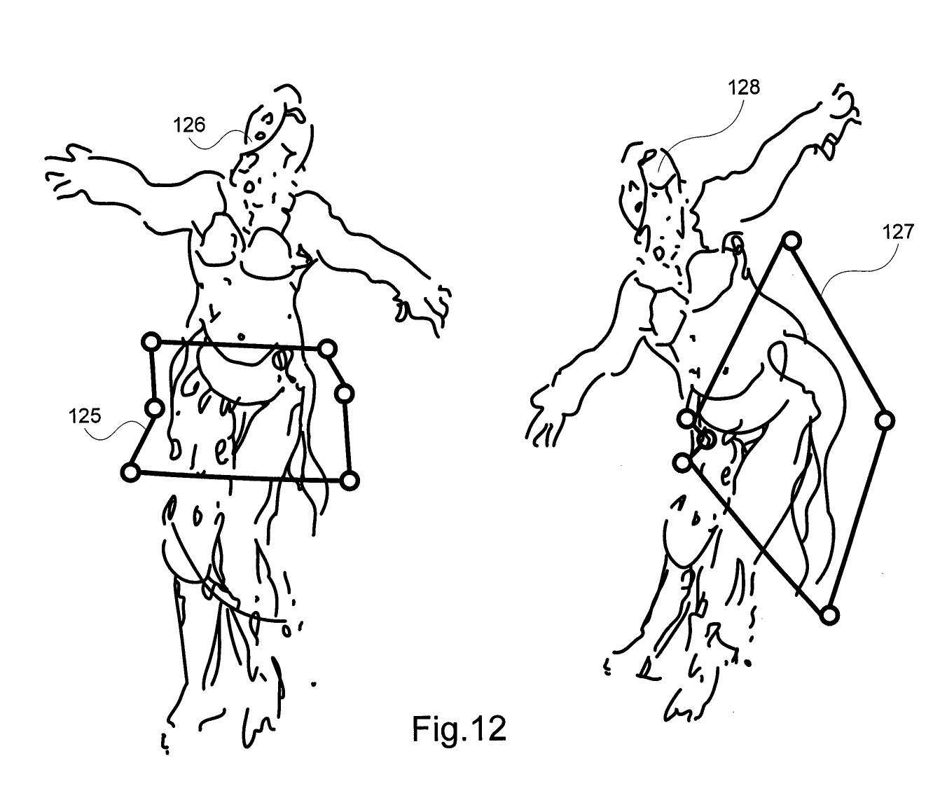

It is possible to extend the coordinates through every face. However, generally it is not possible to extend the coordinates analytically over the whole space. Yet, it is enough for our purpose to define an extension that is smooth on the object to be deformed. The simplest option would be to extend the coordinates through one face, which we call the exit face. The deformation will be smooth through the exit face and through all other faces that undergo the same transformation as the exit face. For a smooth deformation it is enough to ensure that the object does not intersect faces that are not in the above category. One may also apply different extensions (Ej) through several exit faces (tⱼ). The guiding line for a smooth extension here is that the object outside the cage can be decomposed into disconnected parts Oj, such that tj C Oj, and thus each Oj would be subject to a different (corresponding) extension Ej. FIG. 12 shows the extension through two edges (tj, tk) colored red.

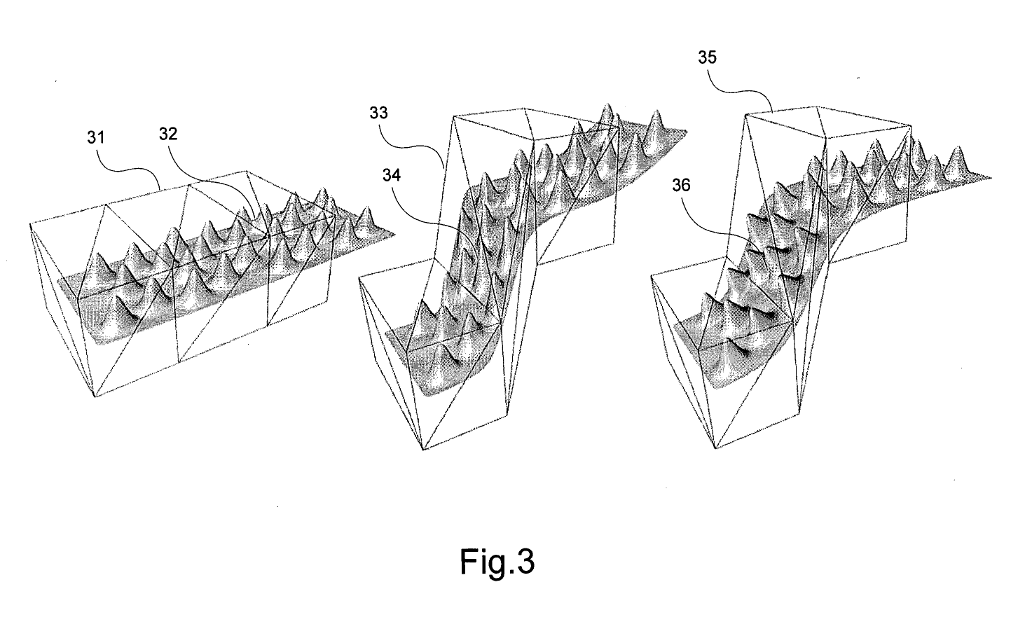

For different results of partial cage deformations, see FIGS. 3, 5, 10. An interesting point which appears in these examples (especially in FIG. 10), is that although the Mean Value Coordinates are well defined and smooth everywhere outside the cage [Hormann and Floater 2006], their influence is not decaying outside the cage, and the effect of partial cage manipulation is not local. Note that Harmonic Coordinates are not defined outside the cage.

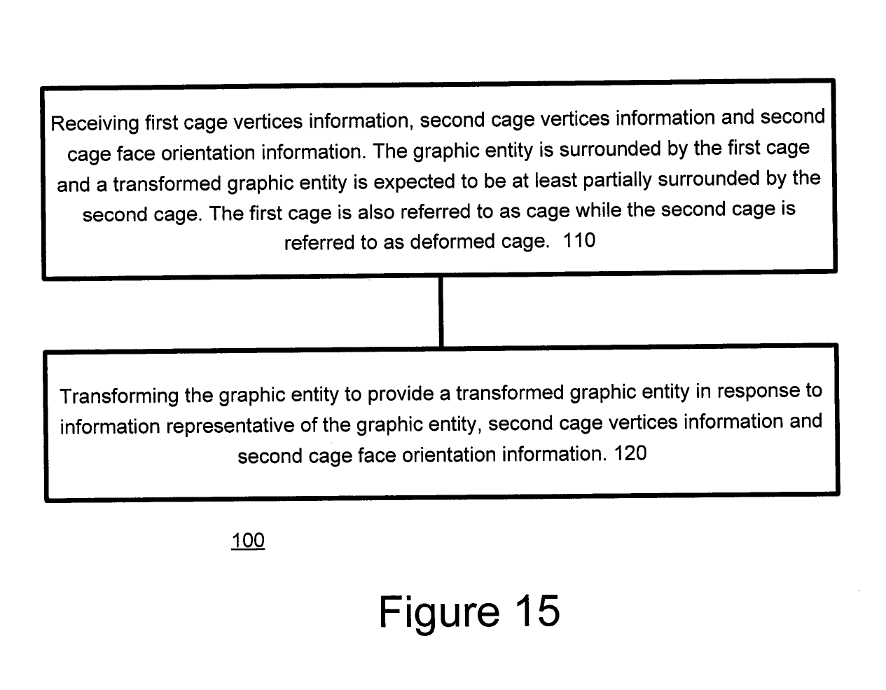

FIG. 15 illustrates method 100 for manipulating a graphic entity according to an embodiment of the invention. Method 100 starts by stage 110 of receiving first cage vertices information, second cage vertices information and second cage face orientation information. The graphic entity is at least partially at least partially surrounded by the first cage and a transformed graphic entity is expected to be at least partially surrounded by the second cage. The first cage is also referred to as cage while the second cage is referred to as deformed cage. Stage 110 can also include receiving or calculating first cage face orientation information. Stage 110 can include calculating the second cage face orientation information.

Stage 110 can include building a first cage (with simplicial faces) surrounding the part of the entity which the user would like to deform, and a second cage, which is a deformation of the first cage. The deformation of the entity is then guided by the deformation of the first cage.

Stage 110 is followed by stage 120 of transforming the graphic entity to provide a transformed graphic entity in response to information representative of the graphic entity, second cage vertices information and second cage face orientation information.

Conveniently, the face orientation information represents vectors that are oriented in relation to faces of the second cage.

Conveniently, the face orientation information represents vectors that are the outward normal to faces of the second cage. If, for example, the second cage is a triangular mesh then each vector is a normal to a triangle out of the triangular mesh.

Conveniently, stage 120 includes adding a first weighted sum of second cage vertices values to a second weighted sum of second cage face orientation values. Appendix 0 and especially the section titled “Green coordinates” and equation (4) illustrate a sample of such weighted sums.

conveniently, stage 120 includes comprising calculating or receiving first sum weights and second sum weights. The first sum weights and second sum weights are selected so that the transforming is characterized by linear reproduction, translation invariance, rotation and scale invariance, shape preservation and smoothness.

These weights are referred to as coordinates and especially to as Green coordinates.

Appendix 0 and especially the section titled “Green coordinates” and equation (4) illustrate a sample of such weighted sums. Appendix 0 and especially the sections titled “our approach” and “GC derivation” and the text that follow equation (9) illustrate sample properties of such coordinates (coordinate functions).

Conveniently, method 100 includes representing the graphical entity as a sum of a third weighted sum of first cage vertices values and a fourth weighted sum of first cage face orientation values; wherein first sum weights equal third sum weights and second sum weights equal fourth sum weights.

Appendix 0 and especially the section titled “Green coordinates” and equation (3) illustrate a sample of such weighted sums.

Conveniently, stage 120 of transforming provides a conformal transformation for a two dimensional graphical object and a quasi-conformal transformation for a three dimensional graphical object.

It is noted that a closed-form formula can be provide by various multi-dimensional graphic entities. Appendix 0 and especially the section titled “closed-form formulas for d=2,3” illustrate a sample of such closed-form formulas. Appendix A (of appendix 0) provides pseudo-code for implementing these closed-form formulas.

Conveniently, stage 120 of transforming comprises extending the transformed graphic entity to an exterior of the second cage. Appendix 0 and 10 especially the section titled “extending to the exterior” illustrate a sample of such extension.

According to an embodiment of the invention the first cage is a partial cage that surrounds a graphic entity that is a part of a larger graphic entity; wherein the larger graphic entity is not at least partially surrounded by the first cage.

According to an embodiment of the invention the second cage is a partial cage that surrounds a transformed graphic entity that is a part of a larger transformed graphic entity; wherein the larger transformed graphic entity is not surrounded by the second cage. Appendix 0 and especially the section titled “extending to the exterior” illustrate a sample of such cages. A cage that does not surrounds (but rather partially surrounds) a graphical entity (or a transformed graphical entity) is referred to as a partial cage.

Stage 120 can include calculating transformation functions (φand ψ) for reach point of the graphic entity. This is illustrated in Appendix A.

In a two dimensional cage the calculating includes setting all φᵢ and all ψᵢ to zero; wherein i is an index indicative of a vertex of the first cage and calculating for each point (η) of the graphic entity multiple coordinate functions φ and ψ. The calculating includes repeating, for each face (denoted by j) of the first cage that has vertices vⱼ₁ and vⱼ₂ the following calculations: a=vⱼ₂−vⱼ₁; b=vⱼ₁−η; Q=a*a; S=b*b; R=2a*b; BA=b*(length of a)*n(tⱼ); SRT=square root of (4*S*Q−R*R); L0=Log(S); L1=Log(S+Q+R); A0=(1/SRT)*arctangents (R/SRT); A1=(1/SRT)*arctangents ((2Q+R/SRT); A10=A1−A0; L10=L1-L0; ψᵢ(η)=(−1/4π)*|a|*[(4S−R2/Q)*A10+(R/2Q)*L10+L1−2]; φⱼ₂(η)=φⱼ₂(η)−(BA/2π)*[L10/2Q−A10*(2+R/Q]; and φⱼ₁(η)=φⱼ₁(η)+(BA/2π)*[L10/2Q−A10*(2+R/Q)].

In a three dimensional cage the calculating includes: setting all φᵢ and all ψᵢ to zero; wherein i is an index indicative of a vertex of the first cage; calculating for each point (η) of the graphic entity multiple coordinate functions φ and ψ; wherein the calculation includes: repeating, for each face (denoted by j) of the first cage that has vertices vⱼ₁, vⱼ₂ and vⱼ₃ the following calculations: vⱼ₁=vⱼ₁−η; vⱼ₂=vⱼ₂−η; vⱼ₃=vⱼ₃−η; p=(vⱼ₁*n(tⱼ))*n(tⱼ); s₁=sign(((vⱼ₁−p)×(vⱼ₂−p))*n(tⱼ); I₁=procedure GCTriInt (p, vⱼ₁, vⱼ₂, 0); II₁=procedure GCTriInt (p, vⱼ₂, vⱼ₁, 0); q₁=vⱼ₂×vⱼ₁; N₁=q₁/(length of q₁); s₂=sign(((vⱼ₂−p)×(vⱼ₃−p))*n(tⱼ); I₂=procedure GCTriInt (p, vⱼ₂, vⱼ₃, 0); II₂=procedure GCTriInt (p, vⱼ₃, vⱼ₂, 0); q₂=vⱼ₃×vⱼ₂; N₂=q₂/length of q₂); s₃=sign(((vⱼ₃−p)×(vⱼ₁−p))*n(tⱼ); I₃=procedure GCTriInt (p, vⱼ₃, vⱼ₁, 0); II₃=procedure GCTriInt (p, vⱼ₁, vⱼ₃, 0); q₃=vⱼ₁×vⱼ₃; N₃=q₃/(length of q₃); I=s₁I₁+s₂I₂+s₃I₃; ψⱼ(η)=−I; w=n(tⱼ)l+(II₁*N₁+II₂*N₂+II₃*N₃); wherein if the absolute value of w is bigger than variable ε then: φⱼ₁(η)=φⱼ₁(η)+(w*N₂)/(N₂*vⱼ₁); φⱼ₂(η)=φⱼ₂(η)+(w*N₁)/N₁*vⱼ₂); and φⱼ₃(η)=φⱼ₃(η)+(w*N₁)/(N₁*vⱼ₃).

Wherein the calculation of procedure GCTriInt includes: receiving p, v₁ and v₂ and η; calculating: α=arccosine [(v₂−v₁)*(p−v₁)/{(absolute value of v₂−v₁)*absolute value of p−v₁)}]; β=arccosine [(v₁−p)*(v₂−p)/{(absolute value of v₁−p)*absolute value of v₂−p)}]; λ=sinus(α)*(length of (p−v₁))²; c=(length of (p−η))²; S=sinus(π−α); C=cosine(π−α); I(π−α)=−sign(S)/2*{[2*(√c)*arctangent [(√c)*C/√(λ+S²*c)]+√λ*log {(2*√λ*S²)/(1−C)²*(1−2*c*C/{c*(1+C)+λ+√(λ²+λ*c*S²)})}; S=sinus(π−α−β); C=cosine(π−α−β); I(π−α−β)=−sign(S)/2*{[2*(√c)*arctangent [(√c)*C/√(λ+S²*c)]+√λ*log {(2*√λ*S²)/(1−C)²*(1−2*c*C/{c*(1+C)+λ+√(λ²+λ*c*S²)})}; and returning, as an outcome of the function, the following value”−1/(4π)*absolute value of (I(π−α)−I(π−α−β)−β*√c).

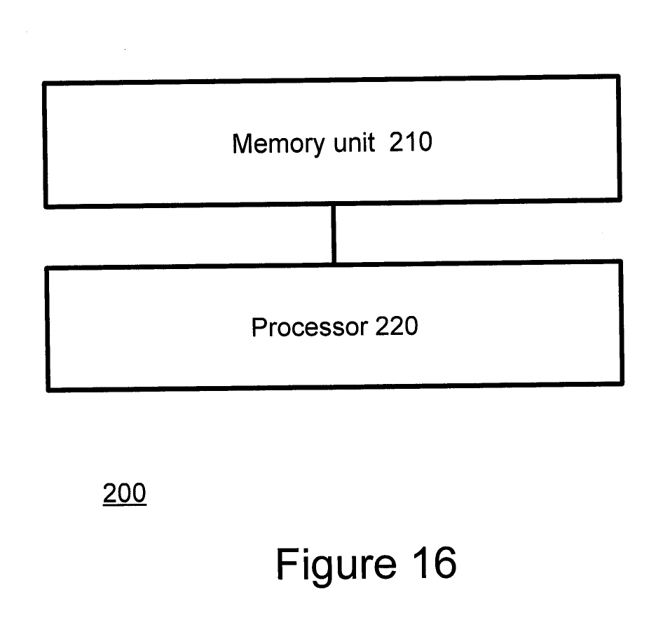

FIG. 16 illustrates system 200 according to an embodiment of the invention. System 200 includes memory unit 210 and processor 220. Memory unit 210 is adapted to store first cage vertices information, second cage vertices information and second cage face orientation information; wherein the graphic entity at least partially surrounded by the first cage and wherein a transformed graphic entity is expected to be at least partially surrounded by the second cage. Processor 220 is adapted to transform the graphic entity to provide a transformed graphic entity in response to information representative of the graphic entity, second cage vertices information and second cage face orientation information.

Conveniently, the face orientation Information represents vectors that are oriented in relation to faces of the second cage.

Conveniently, the face orientation information represents vectors that are the outward normal to faces of the second cage.

Conveniently, the processor is adapted to add a first weighted sum of second cage vertices values to a second weighted sum of second cage face orientation values.

Conveniently, the processor is adapted to calculate or receive first sum weights and second sum weights; wherein the first sum weights and second sum weights are selected so that the transformation is characterized by linear reproduction, translation invariance, rotation and scale invariance, shape preservation and smoothness.

Conveniently, the processor is adapted to represent the graphical entity as a sum of a third weighted sum of first cage vertices values and a fourth weighted sum of first cage face orientation values; wherein first sum weights equal third sum weights and second sum weights equal fourth sum weights.

Conveniently, the transformation is conformal for a two dimensional graphical object and is quasi-conformal for a three dimensional graphical object.

Conveniently, the processor is adapted to extend the transformed graphic entity to an exterior of the second cage.

Conveniently, the first cage is a partial cage that surrounds a graphic entity that is a part of a larger graphic entity; wherein the larger graphic entity is not at least partially surrounded by the first cage.

Accordingly, Green Coordinates for cage-based deformations were illustrated above. The new coordinates provide shape-preserving mappings from the space R^{d} into itself. For the d=2,3 cases, the inventors extracted closed-form formulas to simplify their computation. It is proved that in the 2D case the deformations are conformal, and the inventors shown that they extend to quasi-conformal in 3D. Furthermore, it is shown that the coordinates can be analytically extended to the exterior of the cage allowing the usage of partial cages.

The deformation is not interpolatory. This can be considered as a limitation in applications that require interpolation of the cage's boundary. However, a cage is defined quite loosely around the shape, and the cage is a rather convenient deformation tool for articulating shapes.

It is noted that the definition of conformal mappings has been extensively investigated and it typically involves complex constructions and approximate numerical solutions. Here, the target domain is not prescribed or given as constraints. The target domain is defined on the fly to resemble the geometry of a target cage. The inventors found it surprising that these conformal and quasi-conformal mappings come in such simple, closed-form formulas.

Accordingly, those of skill in the art will appreciate that there are further applications for Green Coordinates beyond deformations.

In the following figures the following numbers are associated with:

FIG. 1A-1F—first or second cage=1, 3, 5, 6, 7, 9, 11, 13 and 15; graphic entity or transformed graphic entity=2, 4, 8, 10, 12, 14 and 16.

FIG. 2—cage=21, 23 and 25; graphic entity=22, 24, 26, 27, 27′, 27″, 28, 28′ and 28″.

FIG. 3—cage=31,33 and 35; graphic entity=32,34 and 36.

FIG. 4—cage=41,43 and 45; graphic entity=42,44 and 46.

FIG. 5—cage=51 and 53; graphic entity=52 and 54.

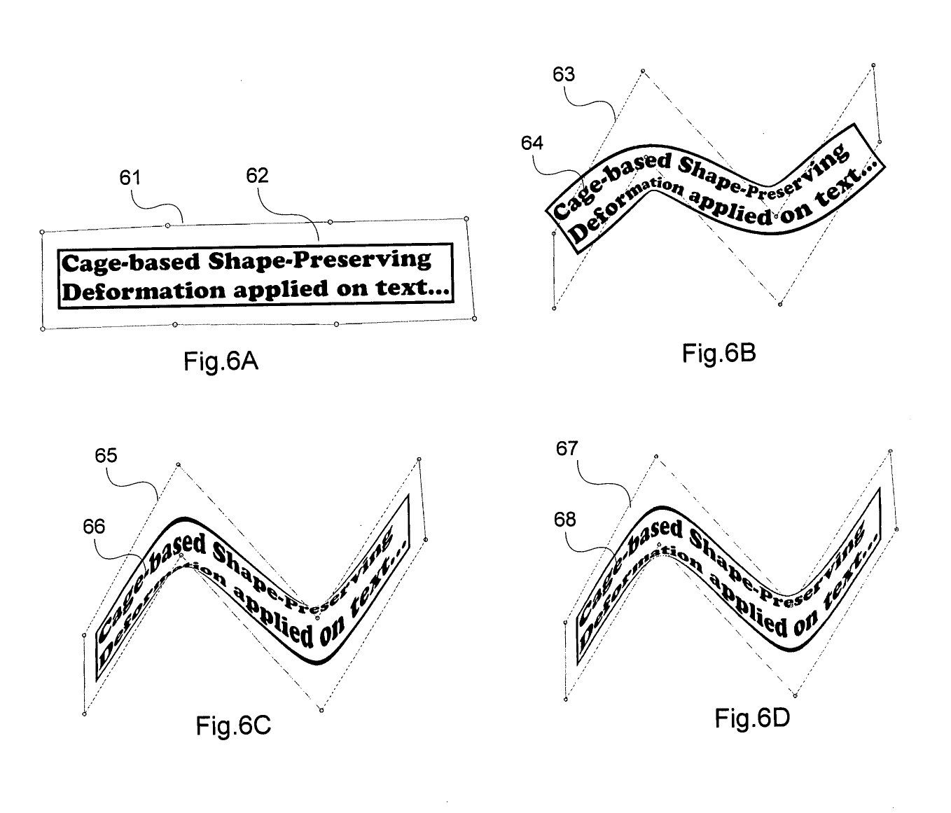

FIG. 6A-6D—cage=61, 63, 65 and 67; graphic entity=62,64,66 and 68.

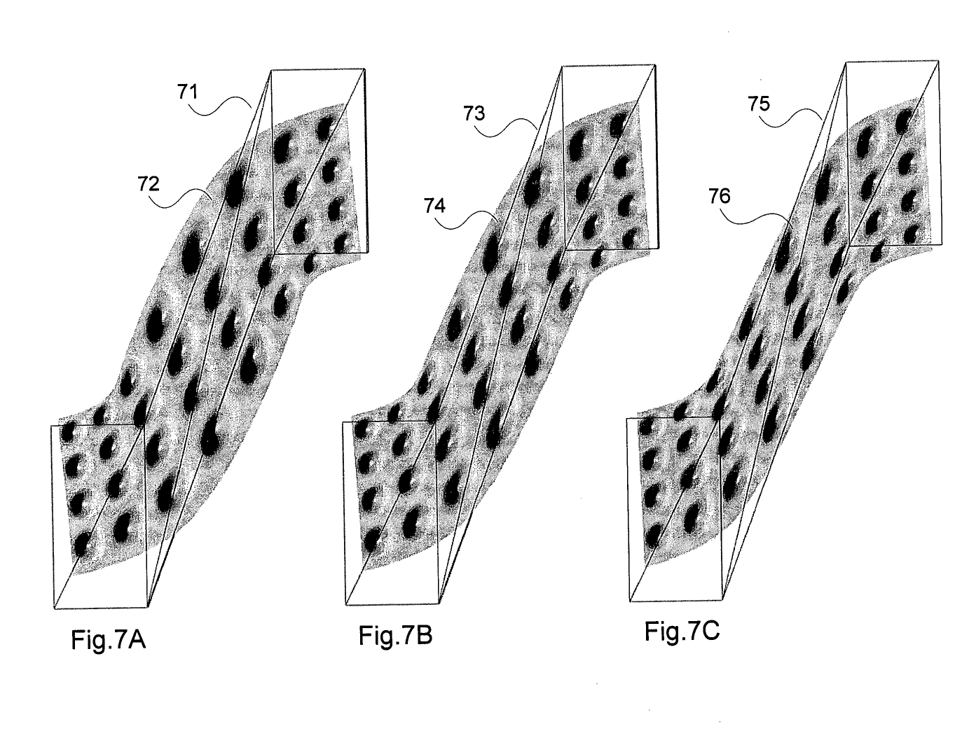

FIGS. 7A-7C—cage=71,73 and 75; graphic entity=72, 74 and 76.

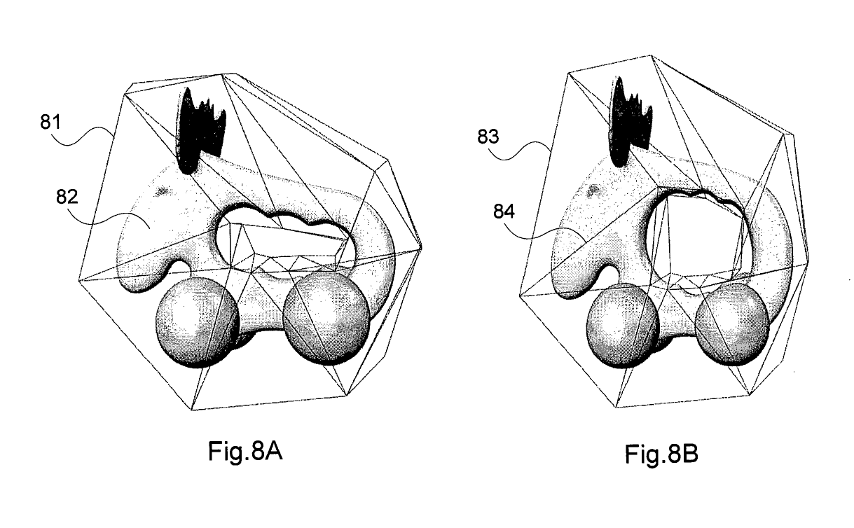

FIGS. 8A-8B—cage=81 and 83; graphic entity=82 and 84.

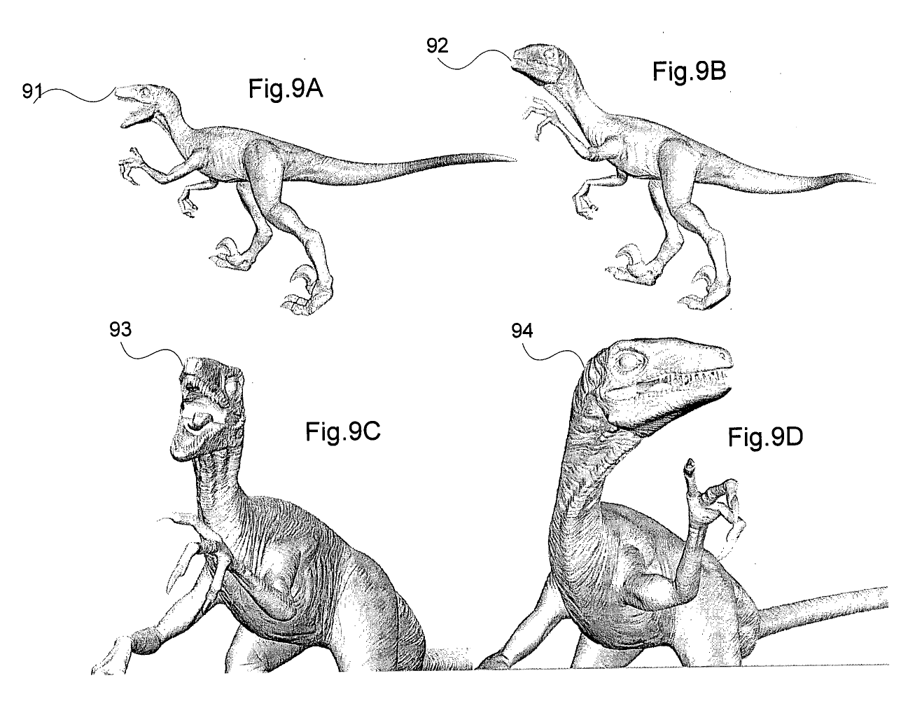

FIGS. 9A-9D—graphic entity=91-94.

FIGS. 10A-10B—cage=101 and 103; graphic entity=102 and 104.

FIGS. 11A-11B—cage=111, 113, 115, 117, 119 and 121; graphic entity=112, 114, 116, 118, 120 and 122.

FIG. 12—cage=125 and 127; graphic entity=126 and 128.

FIG. 13—cage=131, 133, 135, 137, 139, 141 and 143; graphic entity=132, 134, 136, 138, 140, 142 and 144.

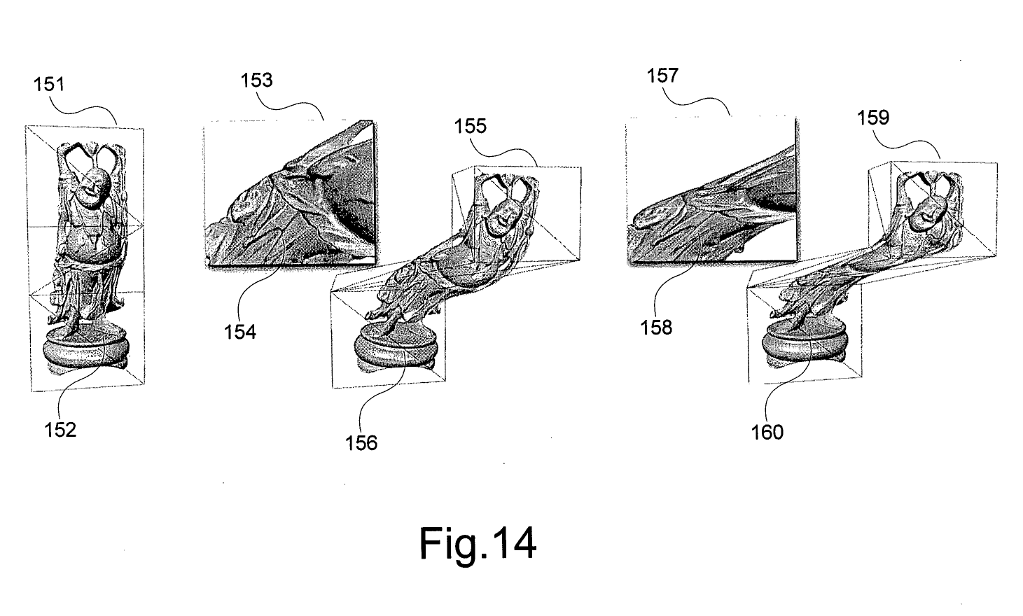

FIG. 14—cage=151, 153, 155, 157 and 159; graphic entity=152, 154, 156, 158 and 160.

Variations, modifications, and other implementations of what is described herein will occur to those of ordinary skill in the art, without departing from the spirit and the scope of the invention as claimed.

Accordingly, the invention is to be defined not by the preceding illustrative description but instead by the spirit and scope of the following claims.

1. A method for manipulating a graphic entity, the method comprising:
receiving first cage vertices information, second cage vertices information and second cage face orientation information; wherein the graphic entity at least partially surrounded by the first cage and wherein a transformed graphic entity is expected to be at least partially surrounded by the second cage; and
transforming the graphic entity to provide a transformed graphic entity in response to information representative of the graphic entity, second cage vertices information and second cage face orientation information.

2. (canceled)

3. (canceled)

4. The method according to claim 1 comprising adding a first weighted sum of second cage vertices values to a second weighted sum of second cage face orientation values.

5. The method according to claim 4 comprising calculating or receiving first sum weights and second sum weights; wherein the first sum weights and the second sum weights are selected so that the transforming is characterized by linear reproduction, translation invariance, rotation and scale invariance, shape preservation and smoothness.

6. The method according to claim 4 comprising representing the graphical entity as a sum of a third weighted sum of first cage vertices values and a fourth weighted sum of first cage face orientation values; wherein first sum weights equal third sum weights and second sum weights equal fourth sum weights.

7. (canceled)

8. (canceled)

9. (canceled)

10. (canceled)

11. The method according to claim 1 further comprising printing the transformed graphic entity.

12. A non-transitory computer readable medium that stores instructions for:
receiving first cage vertices information, second cage vertices information and second cage face orientation information; wherein the graphic entity at least partially surrounded by the first cage and wherein a transformed graphic entity is expected to be at least partially surrounded by the second cage; and
transforming the graphic entity to provide a transformed graphic entity in response to information representative of the graphic entity, second cage vertices information and second cage face orientation information.

13. The non-transitory computer readable medium of claim 12 wherein the face orientation information represents vectors that are oriented in relation to faces of the second cage.

14. The non-transitory computer readable medium of claim 12 wherein the face orientation information represents vectors that are the outward normal to faces of the second cage.

15. The non-transitory computer readable medium of claim 12 that stores instructions for adding a first weighted sum of second cage vertices values to a second weighted sum of second cage face orientation values.

16. The non-transitory computer readable medium of claim 15 that stores instructions for calculating or receiving first sum weights and second sum weights; wherein the first sum weights and second sum weights are selected so that the transforming is characterized by linear reproduction, translation invariance, rotation and scale invariance, shape preservation and smoothness.

17. The non-transitory computer readable medium of claim 15 that stores instructions for representing the graphical entity as a sum of a third weighted sum of first cage vertices values and a fourth weighted sum of first cage face orientation values; wherein first sum weights equal third sum weights and second sum weights equal fourth sum weights.

18. (canceled)

19. (canceled)

20. The non-transitory computer readable medium of claim 12 wherein the first cage is a partial cage that surrounds a graphic entity that is a part of a larger graphic entity; wherein the larger graphic entity is not at least partially surrounded by the first cage.

21. (canceled)

22. The non-transitory computer readable medium of claim 12 that stores instructions for printing the transformed graphic entity.

23. A system for manipulating a graphic entity, the system comprising: a memory unit for storing first cage vertices information, second cage vertices information and second cage face orientation information; wherein the graphic entity at least partially at least partially surrounded by the first cage and wherein a transformed graphic entity is expected to be at least partially surrounded by the second cage; and a processor adapted to transform the graphic entity to provide a transformed graphic entity in response to information representative of the graphic entity, second cage vertices information and second cage face orientation information.

24. (canceled)

25. (canceled)

26. The system according to claim 23 wherein the processor is adapted to add a first weighted sum of second cage vertices values to a second weighted sum of second cage face orientation values.

27. The system according to claim 26 wherein the processor is adapted to calculate first sum weights and second sum weights; wherein the first sum weights and second sum weights are selected so that the transforming is characterized by linear reproduction, translation invariance, rotation and scale invariance, shape preservation and smoothness.

28. (canceled)

29. (canceled)

30. (canceled)

31. (canceled)

32. (canceled)

33. (canceled)

34. (canceled)

35. The method according to claim 1 wherein the transforming comprises:
setting all φᵢ and ψᵢ to zero; wherein i is an index indicative of a vertex of the first cage;
calculating for each point (η) of the graphic entity multiple coordinate functions φ and ψ; wherein the calculating comprises:
repeating, for each face (denoted by j) of the first cage that has vertices vⱼ₁ and vⱼ₂ the following calculations:
a=vⱼ₂−vⱼ₁; b=vⱼ₁−η; Q=a*a; S=b*b; R=2a*b; BA=b*(length of a)*n(tⱼ); SRT=square root of (4*S*Q−R*R); L0=Log(S); L1=Log(S+Q+R); A0=(1/SRT)*arctangents (R/SRT); A1=(1/SRT)*arctangents ((2Q+R)/SRT); A10=A1−A0; L10=L1−L0;
ψᵢ(η)=(−1/4π)*|a|*[(4S−R²/Q)*A10+(R/2Q)*L10+L1−2];
φⱼ₂(η)=φⱼ₂(η)−(BA/2π)*[L10/2Q−A10*(2+R/Q)]; and
φⱼ₁(η)=(φⱼ₁(η)+(BA/2π)*[L10/2Q−A10*(2+R/Q)].

36. The computer readable medium of claim 12 that stores instructions for
setting all φᵢ and all ψᵢ to zero; wherein i is an index indicative of a vertex of the first cage;
calculating for each point (η) of the graphic entity multiple coordinate functions φ and ψ; wherein the calculating comprises:
repeating, for each face (denoted by j) of the first cage that has vertices vⱼ₁ and vⱼ₂ the following calculations:
a=vⱼ₂−vⱼ₁; b=vⱼ₁−η; Q=a*a; S=b*b; R=2a*b; BA=b*(length of a)*n(tⱼ); SRT=square root of (4*S*Q−R*R); L0=Log(S); L1=Log(S+Q+R); A0=(1/SRT)*arctangents (R/SRT); A1=(1/SRT)*arctangents ((2Q+R)/SRT); A10=A1−A0; L10=L1−L0;
ψᵢ(η)=(−1/4π)*|a|*[(4S−R²/Q)*A10+(R/2Q)*L10+L1−2];
φⱼ₂(η)=φⱼ₂(η)−(BA/2π)*[L10/2Q−A10*(2+R/Q)]; and
φⱼ₁(η)=φⱼ₁(η)+(BA/2π)*[L10/2Q−A10*(2+R/Q)].

37. The system according to claim 23 wherein the processor is adapted to set all φᵢ and all ψᵢ to zero; wherein i is an index indicative of a vertex of the first cage;
calculate for each point (η) of the graphic entity multiple coordinate functions φ and ψ; wherein the calculating comprises:
repeating, for each face (denoted by j) of the first cage that has vertices vⱼ₁ and vⱼ₂ the following calculations:
a=vⱼ₂−vⱼ₁; b=vⱼ₁−η; Q=a*a; S=b*b; R=2a*b; BA=b*(length of a)*n(tⱼ); SRT=square root of (4*S*Q−R*R); L0=Log(S); L1=Log(S+Q+R); A0=(1/SRT)*arctangents (R/SRT); A1=(1/SRT)*arctangents ((2Q+R)/SRT); A10=A1−A0; L10=L1−L0;
ψᵢ(η)=(−1/4π)*|a|*[(4S−R²/Q)*A10+(R/2Q)*L10+L1−2];
φⱼ₂(η)=φⱼ₂(η)−(BA/2π)*[L10/2Q−A10*(2+R/Q)]; and
φⱼ₁(η)=φⱼ₁(η)+(BA/2π)*[L10/2Q−A10*(2+R/Q)].

38. The method according to claim 1 comprising:
setting all φᵢ and all ψᵢ to zero; wherein i is an index indicative of a vertex of the first cage;
calculate for each point (η) of the graphic entity multiple coordinate functions φ and ψ; wherein the calculation comprises:
repeating, for each face (denoted by j) of the first cage that has vertices vⱼ₁, vⱼ₂ and vⱼ₃ the following calculations:
vⱼ₁=vⱼ₁−η; vⱼ₂=vⱼ₂−η; vⱼ₃=vⱼ₃−η; p=(vⱼ₁*n(tⱼ))*n(tⱼ);
s₁=sign(((vⱼ₁−p)×(vⱼ₂−p))*n(tⱼ); I₁=procedure GCTriInt (p, vⱼ₁, vⱼ₂, 0); II₁=procedure GCTriInt (p, vⱼ₂, vⱼ₁, 0); q₁=vⱼ₂×vⱼ₁; N₁=q₁/(length of q₁);
s₂=sign(((vⱼ₂−p)×(vⱼ₃−p))*n(tⱼ); I₂=procedure GCTriInt (p, vⱼ₂, vⱼ₃, 0); II₂=procedure GCTriInt (p, vⱼ₃, vⱼ₂, 0); q₂=vⱼ₃×vⱼ₂; N₂=q₂/(length of q₂);
s₃=sign(((vⱼ₃−p)×(vⱼ₁−p))*n(tⱼ); I₃=procedure GCTriInt (p, vⱼ₃, vⱼ₁, 0); II₃=procedure GCTriInt (p, vⱼ₁, vⱼ₃, 0); q₃=vⱼ₁×vⱼ₃; N₃=q₃/(length of q₃);
I=s₁I₁+s₂I₂+s₃I₃;
ψⱼ(η)=−I;
w=n(tⱼ)I+(II₁*N₁+II₂+II₃*N₃);
if the absolute value of w is bigger than variable ε then: φⱼ₁(η)=φⱼ₁(η)+(w*N₂)/(N₂*vⱼ₁); φⱼ₂(η)=φⱼ₂(η)+(w*N₁)/(N₁*vⱼ₂); and φⱼ₃(η)=φⱼ₃(η)+(w*N₁)/(N₁*vⱼ₃);
wherein the calculation of procedure GCTriIint comprises:
receiving p, v₁ and v₂ and η;
calculating:
α=arccosine [(v₂−v₁)*(p−v₁)/{(absolute value of v₂−v₁)*absolute value of p−v₁)}];
β=arccosine [(v₁−p)*(v₂−p)/{(absolute value of v₁−p)*absolute value of v₂−p)}];
λ=sinus(α)*(length of (p−v₁))²; c=(length of (p−η))²;
S=sinus(π−α); C=cosine(π−α);
I(π−α)=−sign(S)/2*{[2*(√c)*arctangent [(√c)*C/√(λ+S²*c)]+√λ*log {(2*√λ*S²)/(1−C)²*(1=2*c*C/{c*(1+C)+λ+√(λ²+λ*c*S²)})};
S=sinus(π−α−β); C=cosine(π−α−β);
I(π−α−β)=−sign(S)/2*{[2*(√c)*arctangent [(√c)*C/√(λ+S²*c)]+√λ*log {(2*√λ*S²)/(1−C)²*(1−2*c*C/{c*(1+C)+λ+√(λ²+λ*c*S²)})}; and
returning, as an outcome of the function, the following value”−1/(4π)*absolute value of (I(π−α)−I(π−α−β)−β*√c).

39. The system according to claim 23 wherein the processor is adapted to
set all φᵢ and all ψᵢ to zero; wherein i is an index indicative of a vertex of the first cage;
calculate for each point (η) of the graphic entity multiple coordinate functions φ and ψ; wherein the calculation comprises:
repeating, for each face (denoted by j) of the first cage that has vertices vⱼ₁, vⱼ₂ and vⱼ₃ the following calculations:
vⱼ₁=vⱼ₁−η; vⱼ₂=vⱼ₂−η; vⱼ₃=vⱼ₃−η; p=(vⱼ₁*n(tⱼ))*n(tⱼ);
s₁=sign(((vⱼ₁−p)×(vⱼ₂−p))*n(tⱼ); I₁=procedure GCTriInt (p, vⱼ₁, vⱼ₂, 0); II₁=procedure GCTriInt (p, vⱼ₂, vⱼ₁, 0); q₁=vⱼ₂×vⱼ₁; N₁=q₁/(length of q₁);
s₂=sign(((vⱼ₂−p)×(vⱼ₃−p))*n(tⱼ); I₂=procedure GCTriInt (p, vⱼ₂, vⱼ₃, 0); II₂=procedure GCTriInt (p, vⱼ₃, vⱼ₂, 0); q₂=vⱼ₃×vⱼ₂; N₂=q₂/(length of q₂);
s₃=sign(((vⱼ₃−p)×(vⱼ₁−p))*n(tⱼ); I₃=procedure GCTriInt (p, vⱼ₃, vⱼ₁, 0); II₃=procedure GCTriInt (p, vⱼ₁, vⱼ₃, 0); q₃=vⱼ₁×vⱼ₃; N₃=q₃/(length of q₃);
I=s₁I₁+s₂I₂+s₃I₃;
ψⱼ(η)=−I;
w=n(tⱼ)I+(II₁*N₁+II₂*N₂+II₃*N₃);
if the absolute value of w is bigger than variable ε then: φⱼ₁(η)=φⱼ₁(η)+(w*N₂)/(N₂*vⱼ₁); φⱼ₂(η)=φⱼ₂(η)+(w*N₁)/(N₁*vⱼ₂); and φⱼ₃(η)=φⱼ₃(η)+(w*N₁)/(N₁*vⱼ₃);
wherein the processor is adapted to calculate the procedure GCTriIint by:
receiving p, v₁ and v₂ and η;
calculating:
α=arccosine [(v₂−v₁)*(p−v₁)/{(absolute value of v₂−v₁)*absolute value of p−v₁)}];
β=arccosine [(v₁−p)*(v₂−p)/{(absolute value of v₁−p)*absolute value of v₂−p)}];
λ=sinus(α)*(length of (p−v₁))²; c=(length of (p−η))²;
S=sinus(π−α); C=cosine(π−α);
I(π−α)=−sign(S)/2*{[2*(√c)*arctangent [(√c)*C/√(λ+S²*c)]+√λ*log {(2*√λ*S²)/(1−C)²*(1−2*c*C/{c*(1+C)+λ+√(λ²+λ*c*S²)})};
S=sinus(π−α−β); C=cosine(π−α−β);
I(π−α−β)=−sign(S)/2*{[2*(√c)*arctangent [(√c)*C/√(λ+S²*c)]+√λ*log {(2*√λ*S²)/(1−C)²*(1−2*c*C/{c*(1+C)+λ+√(λ²+λ*c*S²)})}; and
returning, as an outcome of the function, the following value” −1/(4π)*absolute value of (I(π−α)−I(π−α−β)−β*√c).

40. The computer readable medium of claim 12 that stores instructions for
setting all φᵢ and all ψᵢ to zero; wherein i is an index indicative of a vertex of the first cage;
calculate for each point (η) of the graphic entity multiple coordinate functions φ and ψ; wherein the calculation comprises:
repeating, for each face (denoted by j) of the first cage that has vertices vⱼ₁, vⱼ₂ and vⱼ₃ the following calculations:
vⱼ₁=vⱼ₁−η; vⱼ₂=vⱼ₂−ηn; vⱼ₃=vⱼ₃−η; p=(vⱼ₁*n(tⱼ))*n(tⱼ);
s₁=sign(((vⱼ₁−p)×(vⱼ₂−p))*n(tⱼ); I₁=procedure GCTriInt (p, vⱼ₁, vⱼ₂, 0); II₁=procedure GCTriInt (p, vⱼ₂, vⱼ₁, 0); q₁=vⱼ₂×vⱼ₁; N₁=q₁/(length of q₁);
s₂=sign(((vⱼ₂−p)×(vⱼ₃−p))*n(tⱼ); I₂=procedure GCTriInt (p, vⱼ₂, vⱼ₃, 0); II₂=procedure GCTriInt (p, vⱼ₃, vⱼ₂, 0); q₂=vⱼ₃×vⱼ₂; N₂=q₂/(length of q₂);
s₃=sign(((vⱼ₃−p)×(vⱼ₁−p))*n(tⱼ); I₃=procedure GCTriInt (p, vⱼ₃, vⱼ₁, 0); II₃=procedure GCTriInt (p, vⱼ₁, vⱼ₃, 0); q₃=vⱼ₁×vⱼ₃; N₃=q₃/(length of q₃);
I=s₁I₁+s₂I₂+s₃I₃;
ψⱼ(η)=−I;
w=n(tⱼ)I+(II₁*N₁+II₂*N₂+II₃*N₃);
if the absolute value of w is bigger than variable ε then: φⱼ₁(η)=φⱼ₁(η)+(w*N₂)/(N₂*vⱼ₁); φⱼ₂(η)=φⱼ₂(η)+(w*N₁)/(N₁*vⱼ₂); and φⱼ₃(η)=φⱼ₃(η)+(w*N₁)/(N₁*vⱼ₃);
wherein the calculation of procedure GCTriIint comprises:
receiving p, v₁ and v₂ and η;
calculating:
α=arccosine [(v₂−v₁)*(p−v₁)/{(absolute value of v₂−v₁)*absolute value of p−v₁)}];
β=arccosine [(v₁−p)*(v₂−p)/{(absolute value of v₁−p)*absolute value of v₂−p)}];
λ=sinus(α)*(length of (p−v₁))²; c=(length of (p−η))²;
S=sinus(π−α); C=cosine(π−α);
I(π−α)=−sign(S)/2*{[2*(√c)*arctangent [(√c)*C/√(λ+S²*c)]+√λ*log {(2*√λ*S²)/(1−C)²*(1=2*c*C/{c*(1+C)+λ+√(λ²+λ*c*S²)})};
S=sinus(π−α−β); C=cosine(π−α−β);
I(π−α−β)=−sign(S)/2*{[2*(√c)*arctangent [(√c)*C/√(λ+S²*c)]+√λ*log {(2*√λ*S²)/(1−C)²*(1−2*c*C/{c*(1+C)+λ+√(λ²+λ*c*S²)})}; and
returning, as an outcome of the function, the following value” −1/(4π)*absolute value of (I(π−α)−I(π−α−β)−β*√c).
